(19) United States
(12) Patent Application Publication
(10) Pub. No.: US 2012/0116869 A1
(43) Pub. Date: May 10, 2012

(54) COORDINATING ADVERTISING AMONG USER DEVICES

(75) Inventors: Venugopal Vasudevan, Palatine, IL (US); Jehan Wickramasuriya, St. Charles, IL (US)

(73) Assignee: Motorola-Mobility, Inc., Libertyville, IL (US)

(21) Appl. No.: 12/941,320

(22) Filed: Nov. 8, 2010

(51) Int. Cl. G06Q 30/00

(52) U.S. Cl. 705/14.44; 705/14.73

(57) ABSTRACT

Disclosed are methods for coordinating advertising among at least two devices currently being used by the same user. A server receives information about what advertising is sent to a first user device. Based on that information, the server creates a “context directive” that specifies how to appropriately direct advertising to a second user device. The context directive is sent to a device that manages an advertising campaign for the second device. The context directive can be based on advertising policy rules set by campaign managers for the first and second user devices. The policy rules may be based on demographic information associated with the user of the second device. In some embodiments, a server collects information on advertisements sent to the various user devices, correlates that information, and produces a report. Advertising managers use this report to gauge the effectiveness of their campaigns across devices.

### FIELD OF THE INVENTION

The present invention is related generally to electronic communications and, more particularly, to electronically transmitted advertisements.

### BACKGROUND OF THE INVENTION

Recently, advertisers have begun to look beyond “traditional” media (e.g., magazines and television) and have begun looking to “new media” (e.g., online and mobile services) to increase the effectiveness of their advertising campaigns. Online advertising is appealing because an advertiser can put an advertisement in front of an audience that is actively searching for information. This allows the advertiser to tap into the needs of people prepared to buy rather than, as in the traditional approach, blindly sending advertisements to people who are simply watching television or reading a print medium.

However, even as people spend more time online, traditional media remain very important (and they still receive the majority of advertising dollars). Indeed, rather than simply replacing traditional media time with online time, many people are beginning to combine traditional and new media. For example, while they watch television, they also pay attention to a “companion device” (e.g., a laptop computer or a smart phone). These users then receive advertising both through the television and through the companion device.

Because these media are very different, the advertising delivered through them can be very different. For example, television viewing is at least potentially a shared experience, while interacting with a companion device is generally a private activity, and the advertising campaigns reflect this difference in focus. Because of this difference, the user may receive conflicting advertisements. This conflict confuses the user and may lead to “advertising dissonance.” The dissonance makes the user less receptive to either advertising campaign and thus decreases the effectiveness of both campaigns.

### BRIEF SUMMARY

The above considerations, and others, are addressed by the present invention, which can be understood by referring to the specification, drawings, and claims. According to aspects of the present invention, advertising is coordinated among at least two devices currently being used by the same user. A server receives information about what advertising is sent to a first user device. Based on that information, the server creates a “context directive” that specifies how to appropriately direct advertising to a second user device. The context directive is sent to a device that manages an advertising campaign for the second device.

The context directive can be based on advertising policy rules set by campaign managers for the first and second user devices. For example, the server may know that an advertisement for a soft drink was just sent to the first user device. Based on the policy rule, the server may create a context directive telling the second campaign manager not to send an advertisement for a competing soft drink to the second user device, at least for a specified period of time. This prevents “advertising dissonance” and potentially makes the soft-drink advertising campaign more effective.

The policy rules may be based on demographic information associated with the user of the second device. If, for example, the user is known to be a teenager, then when a car advertisement is shown on the television, an interactive game based on that car can be sent to the teenager's smart phone.

In some embodiments, a server collects information on advertisements sent to the various user devices, correlates that information, and produces a report. Advertising managers use this report to gauge the effectiveness of their campaigns across devices.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a generalized schematic of the advertising-coordination server shown in FIG. 1; and

FIGS. 3a and 3b together form a flowchart of a method for coordinating advertising among user devices.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

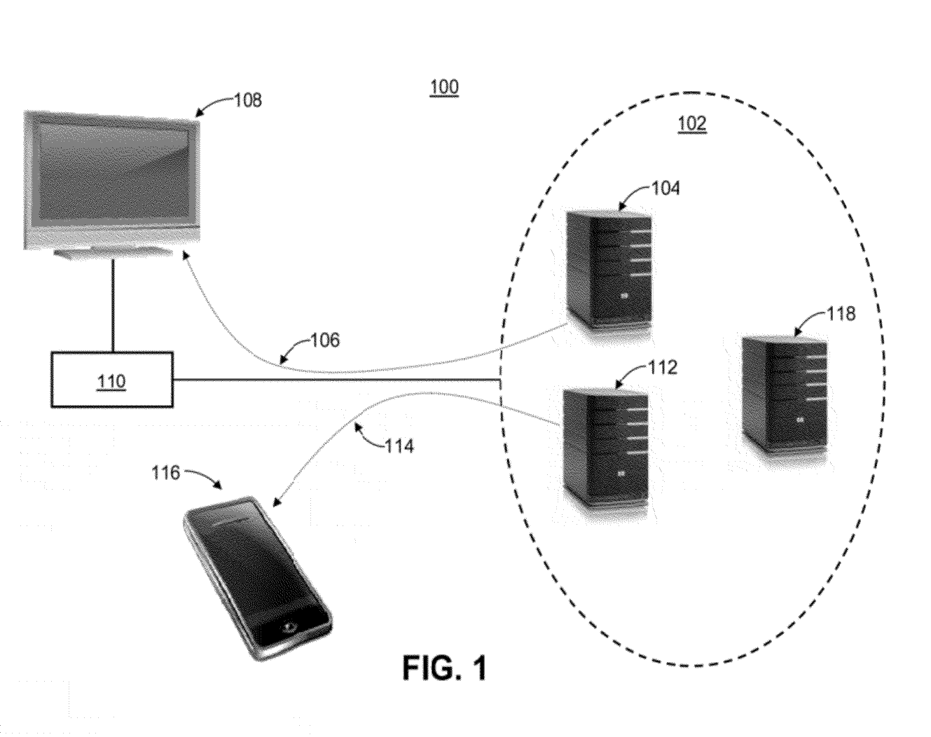

Aspects of the present invention may be practiced in the representative communications environment 100 of FIG. 1. Connected together via any or all of the various known networking technologies 102 are servers such as advertising campaign managers 104, 112 and an advertising-coordination server 118.

The first advertising campaign manager 104 delivers advertising 106 to a first user device 108. Here, the first user device 108 is shown as a television monitor. In some situations, the advertising campaign manager 104 actually delivers the advertising 106 to a set-top box 110, and the set-top box 110 delivers the advertising 106 to the television monitor 108. These sorts of connection options are well known in the art and need not be further discussed.

The second advertising campaign manager 112 delivers advertising 114 to a second user device 116. The first and second advertising campaign managers 104, 112 may be hosted on the same server, but in a general scenario they are hosted on separate servers and may even be provided by different advertising agencies.

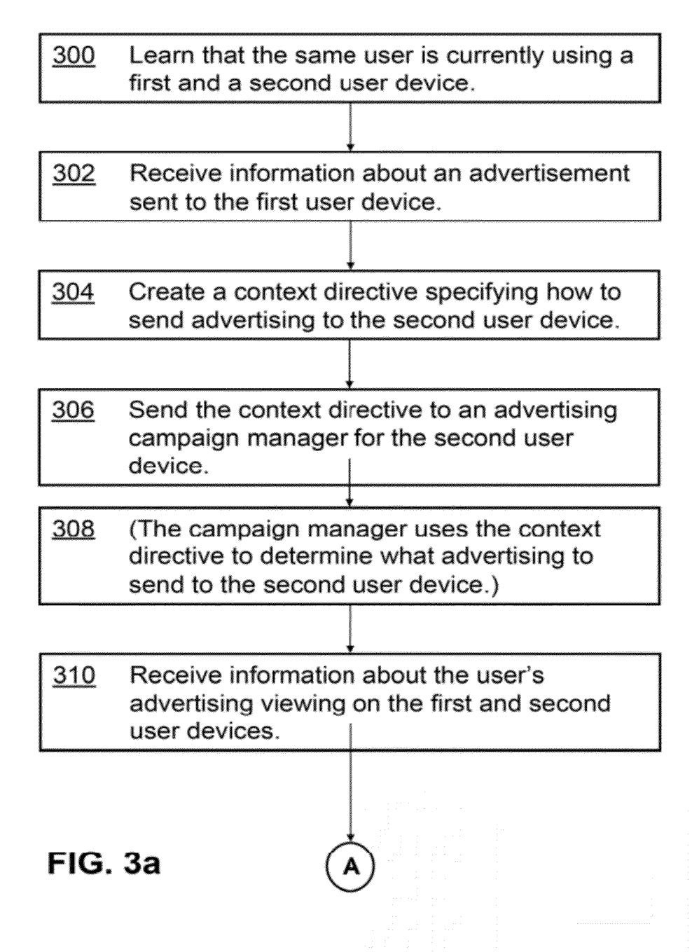

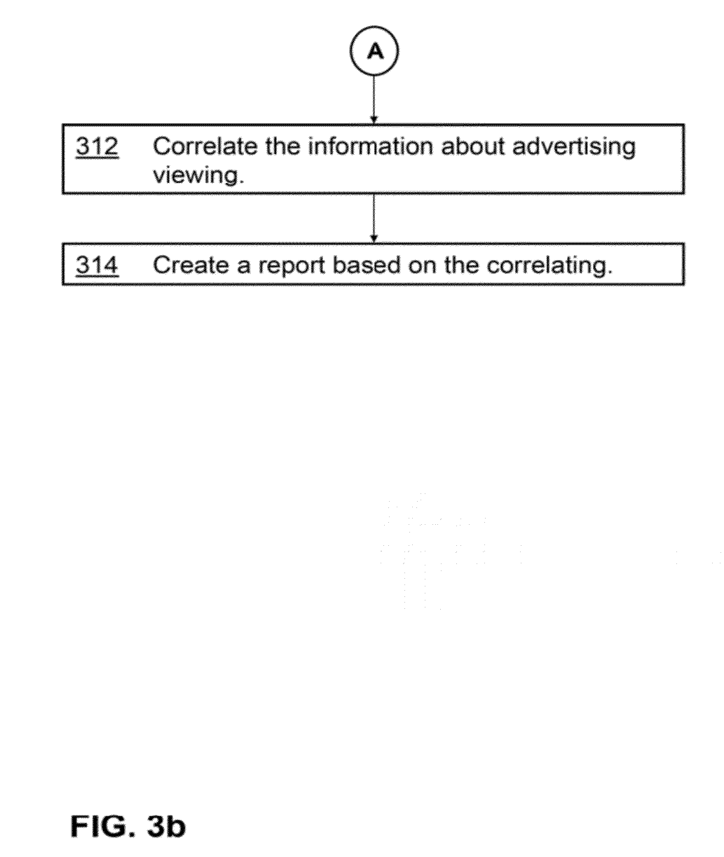

This second user device 116 is shown as a smart phone, a typical “companion device.” This cellular telephone 116 communicates wirelessly to a wireless base station (not shown but known in the art) to access the public switched telephone network, the Internet, or other networks to access the services provided by the servers 112, 118. There is no requirement that the “first” user device 108 be a shared-experience device while the “second” user device 116 is a personal device. These two (or more) user devices 108, 116 can even swap roles during the method described below in connection with FIGS. 3a and 3b. Other possible user devices include a personal computer, tablet, digital video recorder, home gateway, digital kiosk, and digital sign.

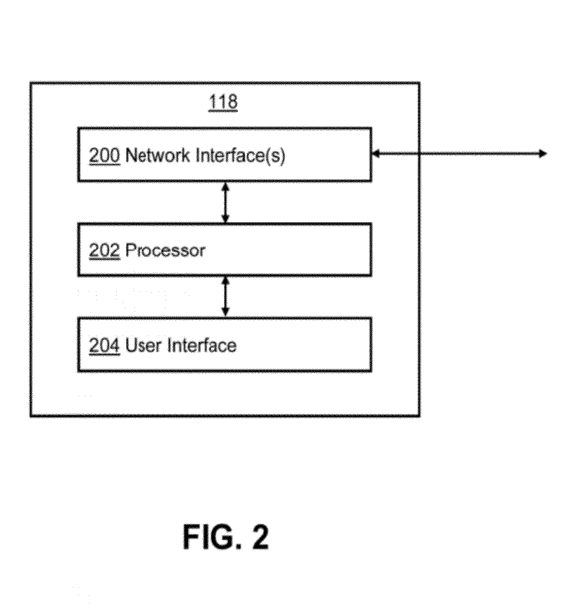

FIG. 2 shows the major components of a representative advertising-coordination server 118. Network interfaces 200 send context directives and advertising reports and receive information about advertising viewing, as discussed below. A processor 202 controls the operations of the server 118 and, in particular, supports aspects of the present invention as illustrated in FIGS. 3a and 3b, discussed below. The user interface 204 supports an administrator's interactions with the server 118.

The flowchart of FIGS. 3a and 3b illustrates aspects of the present invention as embodied in the advertising-coordination server 118. (Note that this flowchart is primarily intended to support the following discussion. The “steps” in the flowchart are, in some embodiments and in some situations, optional and may be performed in a different order, if at all.)

In step 300 of FIG. 3a, the advertising-coordination server 118 learns that the same user is currently using the first and second user devices 108, 116. This step is optional. As with many advertising campaigns, the more information available about the audience, the better can advertisements be directed toward members of that audience. While aspects of the present invention may be most effective when the server 118 is privy to the information in step 300, in situations where that information is not available, the server 118 performs the following steps as best it can.

There are many known techniques for gathering the information of step 300. For example, subscription records for a cable television 108 and for a cellular telephone 116 may be available in some situations. More specifically, a user may have logged into a service via one or the other of the devices 108, 116, and this login information may become available to the advertising-coordination server 118. In the ever-expanding field of social networking, techniques for gathering “presence information” are known and may be usefully applied in step 300.

The advertising-coordination server 118 learns, in step 302, that an advertisement has been sent to the first user device 108. The server 118 may learn this when the advertisement is actually being delivered, e.g., by the set-top box 110 reporting that it has received and is playing the advertisement. (In many cable-television implementations, the set-top box 110 views metadata associated with the media sent to it, so it can know that this is an advertisement.) In some situations, the advertising campaign manager 104 for the first user device 108 tells the server 118 this information, possibly giving advance notice of a schedule of advertisements that it intends to deliver to the device 108.

Note that according to the wording of step 302 of FIG. 3a, the information delivered is about an advertisement that is “sent” to the first user device 108. Step 302 says nothing about whether or not the advertisement was actually “viewed” by the user. If the actual viewing information is available, then it should certainly be used in step 302. However, the reality is that in some situations, that information is simply not available. This is another example of a situation where aspects of the present invention are more efficient with better information but can still be useful with whatever information is available.

The advertising-coordination server 118 uses the information gathered in step 302 to create a “context directive” in step 304. Based on policy rules, this context directive contains information for coordinating the advertising campaigns on the two user devices 108, 116. For example, if a soft-drink advertisement was just delivered to the first user device 108, then a policy rule might state that an advertisement for a different soft-drink should not be sent to the second user device 116, at least for a short period of time. The thinking behind this policy rule is that the user may tend to ignore the second of two advertisements directed toward the same type of product when the two advertisements are delivered in a short interval of time. In this situation, the context directive can direct the advertising campaign manager 112 to not send a soft-drink advertisement to the second user device 116 for, say, the next five minutes.

Another policy rule may prevent the sending of simultaneous advertisements whose emotional context would clash. For example, the rule might say do not send an advertisement for an upcoming comedy show to the second user device 116 if an advertisement for a funeral home was just displayed on the first user device 108.

When creating the context directive, the advertising-coordination server 118 can look to demographic information, if it is available. If, for example, a car advertisement is shown on the first user device 108, and if the user is known to be a teenager, then advertising “synergy” can be fostered by delivering a car-chase game featuring the advertised car to the second user device 116.

Sophisticated embodiments can take advantage of the user's viewing behavior gathered over a long period of time. This behavior can be used to formulate policy rules. For example, if the user is know to have watched several soccer games over the past week, then a “dual-screen” advertising campaign can be implemented, via the policy rules, to direct specific soccer-related advertising (or soccer-themed advertising for products that inherently have nothing to do with soccer, e.g., soft drinks) to both the first and the second user devices 108, 116.

It should be borne in mind that in some situations, the advertising campaign managers 104, 112 are distinct and may even represent competing products. Thus, some of the policy rules will be stated in negative terms, e.g., do not show my advertisement within five minutes of a competing advertisement.

The policy rules given above all tend to prevent “advertisement dissonance” in the user of the two user devices 108, 116. By preventing dissonance, the policy rules can increase the effectiveness of the advertising campaigns on both user devices 108, 116 and encourage advertisers to direct more advertising money to these types of devices.

In step 306, the context directive is sent to the advertising campaign manager 112 for the second user device 116. In some situations, the advertising campaign managers 104, 112 and the advertising-coordination server 118 may be functions hosted on the same physical device. However, the present invention is flexible enough to handle disparate devices run by different corporate entities.

Note that the method of FIGS. 3a and 3b can be implemented in a “push” environment, or in a “pull” environment, or in some combination. That is to say, the intelligence for deciding that a context directive should be sent in step 306 can in either of the advertising campaign managers 104, 112, or in the advertising-coordination server 118, or even in the user devices 108, 116 themselves.

Step 308 is not performed by the advertising-coordination server 118. It is included to show that the advertising campaign manager 112 can use the received context directive when making its decisions about sending advertising to the second user device 116.

Step 310 is optional but points to a very useful function that can be provided by the advertising-coordination server 118. Information is collected, where available, about the advertising that the user actually sees. That information is correlated in step 312 of FIG. 3b, and a report is created in step 314. That report can be very useful to the advertising campaign managers 104, 112 in determining the effectiveness of their campaigns.

In view of the many possible embodiments to which the principles of the present invention may be applied, it should be recognized that the embodiments described herein with respect to the drawing figures are meant to be illustrative only and should not be taken as limiting the scope of the invention. For example, many other inputs to the policy rules are contemplated, depending upon the information available. Therefore, the invention as described herein contemplates all such embodiments as may come within the scope of the following claims and equivalents thereof.

We claim:

1. A method for a server to coordinate advertising transmitted to a user device, the method comprising:
receiving, by the server, information about an advertisement transmitted to a first user device;
based, at least in part, on the received information, creating, by the server, a context directive specifying how to transmit advertising to a second user device, the second user device distinct from the first user device; and
sending, by the server, the context directive to an advertising campaign manager for the second user device.

2. The method of claim 1 wherein the first and second user devices are selected from the group consisting of: a television, a mobile telephone, a personal computer, and a tablet computer.

3. The method of claim 1 wherein the advertisement is selected for the first user device by an advertising campaign manager distinct from the advertising campaign manager for the second user device.

4. The method of claim 1 wherein receiving information comprises receiving metadata associated with the advertisement.

5. The method of claim 1 wherein the context directive comprises an element selected from the group consisting of: do not display a type of advertisement, postpone displaying a type of advertisement, display an alternative type of advertisement, and display a game.

6. The method of claim 1 wherein creating the context directive is based, at least in part, on demographic information associated with a user of the second user device.

7. The method of claim 1 further comprising:
receiving, by the server, first information about advertising viewing on the first user device;
receiving, by the server, second information about advertising viewing on the second user device;
correlating, by the server, at least some of the first and second information; and
based, at least in part, on the correlating, creating, by the server, a report.

8. The method of claim 1 further comprising:
learning, by the server, that a same user is currently associated with both the first and the second user devices.

9. The method of claim 8 wherein learning is based, at least in part, on an element selected from the group consisting of: subscription records for the first and second user devices and user-presence information.

10. The method of claim 1 wherein creating a context directive comprises applying a rule associated with the advertisement.

11. The method of claim 10 further comprising:
creating, by the server, the rule associated with the advertisement.

12. A server for coordinating advertising transmitted to a user device, the server comprising:
a network interface configured for receiving information about an advertisement transmitted to a first user device; and
a processor operatively connected to the network interface, the processor configured for:
based, at least in part, on the received information, creating a context directive specifying how to transmit advertising to a second user device, the second user device distinct from the first user device; and
sending, via the network interface, the context directive to an advertising campaign manager for the second user device.

13. The server of claim 12 wherein the context directive comprises an element selected from the group consisting of: do not display a type of advertisement, postpone displaying a type of advertisement, display an alternative type of advertisement, and display a game.

14. The server of claim 12 wherein creating the context directive is based, at least in part, on demographic information associated with a user of the second user device.

15. The server of claim 12 wherein the processor is further configured for:
receiving first information about advertising viewing on the first user device;
receiving second information about advertising viewing on the second user device;
correlating at least some of the first and second information; and
based, at least in part, on the correlating, creating a report.

16. The server of claim 12 wherein the processor is further configure for:
learning that a same user is currently associated with both the first and the second user devices.

17. The server of claim 16 wherein learning is based, at least in part, on an element selected from the group consisting of: subscription records for the first and second user devices and user-presence information.

18. The server of claim 12 wherein creating a context directive comprises applying a rule associated with the advertisement.

19. The server of claim 18 wherein the processor is further configured for:
creating the rule associated with the advertisement.

20. A method for a server to create a report about advertising viewing on user devices, the method comprising:
receiving, by the server, first information about advertising viewing on a first user device;
receiving, by the server, second information about advertising viewing on a second user device, the second user device distinct from the first user device;
correlating, by the server, at least some of the first and second information; and
based, at least in part, on the correlating, creating, by the server, a report.

21. A server for creating a report about advertising viewing on user devices, the server comprising:
a network interface configured for receiving first information about advertising viewing on a first user device and for receiving second information about advertising viewing on a second user device, the second user device distinct from the first user device; and
a processor operatively connected to the network interface, the processor configured for:
correlating at least some of the first and second information; and
based, at least in part, on the correlating, creating a report.
